(19) United States
(12) Patent Application Publication
(10) Pub. No.: US 2010/0107187 A1
(43) Pub. Date: Apr. 29, 2010

(54) System and Method of Displaying Advertising Content

(75) Inventors: David Krantz, San Antonio, TX (US); Lee Culver, San Antonio, TX (US); Justin Marcucci, Chester, NJ (US); Susan Novell, Dallas, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/257,593

(22) Filed: Oct. 24, 2008

(51) Int. Cl. H04N 7/10

(52) U.S. Cl. 725/32

(57) ABSTRACT

A system and method of displaying advertising content are provided. The system to display advertising content includes a three-dimensional graphical display module to generate an interactive three-dimensional user interface display. The system also includes an advertising module to display advertising content at the three-dimensional user interface display. The system further includes advertising content displayable using a plurality of views. A first view of the plurality of views is adapted for display at a first viewer perspective and a second view of the plurality of views is adapted for display at a second viewer perspective.

### FIELD OF THE DISCLOSURE

The present disclosure is generally related to a system and method of displaying advertising content.

### BACKGROUND

Advertisers seek to get and keep the public's attention in order to generate sales. Advertisers may put considerable time and expense into finding effective modes of advertising. One aspect advertisers may consider is how best to provide information to their target market. Online advertising has opened up new opportunities to target advertising to individuals. Hence, there is a need for an improved system and method of displaying advertising content.

### BRIEF DESCRIPTION OF THE DRAWINGS

FIG. 1 is a diagram of an embodiment of a system to display advertising content;

FIG. 2 is a flow diagram of an embodiment of a method of displaying advertising content;

FIG. 3 is an illustration of a first embodiment of a user interface to display advertising content;

FIG. 4 is an illustration of a second embodiment of a user interface to display advertising content;

FIG. 5 is an illustration of a third embodiment of a user interface to display advertising content;

FIG. 6 is an illustration of a fourth embodiment of a user interface to display advertising content;

FIG. 7 is a diagram illustrating a particular embodiment of a viewer perspective; and

FIG. 8 is a block diagram of an illustrative general computer system.

### DETAILED DESCRIPTION OF THE DRAWINGS

A system to display advertising content is provided that includes a three-dimensional graphical display module to generate an interactive three-dimensional user interface display. The system also includes an advertising module to display advertising content at the three-dimensional user interface display. The system further includes advertising content displayable using a plurality of views. A first view of the plurality of views is adapted for display at a first viewer perspective and a second view of the plurality of views is adapted for display at a second viewer perspective.

A method of displaying advertising content is provided. The method includes displaying a first view associated with advertising content at a first display element of an interactive display. The advertising content includes at least the first view and a second view. The method also includes receiving viewer perspective input. The method also includes modifying a viewer perspective of the interactive display based on the viewer perspective input. The method further includes displaying the second view associated with the advertising content based on the modified viewer perspective.

A processor-readable medium including instructions executable by a processor to perform a method of displaying advertising content is provided. The method includes displaying a first view associated with advertising content at a first display element of an interactive display. The advertising content including at least the first view and a second view. The method also includes receiving viewer perspective input. The method further includes modifying a viewer perspective of the interactive display based on the viewer perspective input. The method also includes displaying the second view associated with the advertising content based on the modified viewer perspective.

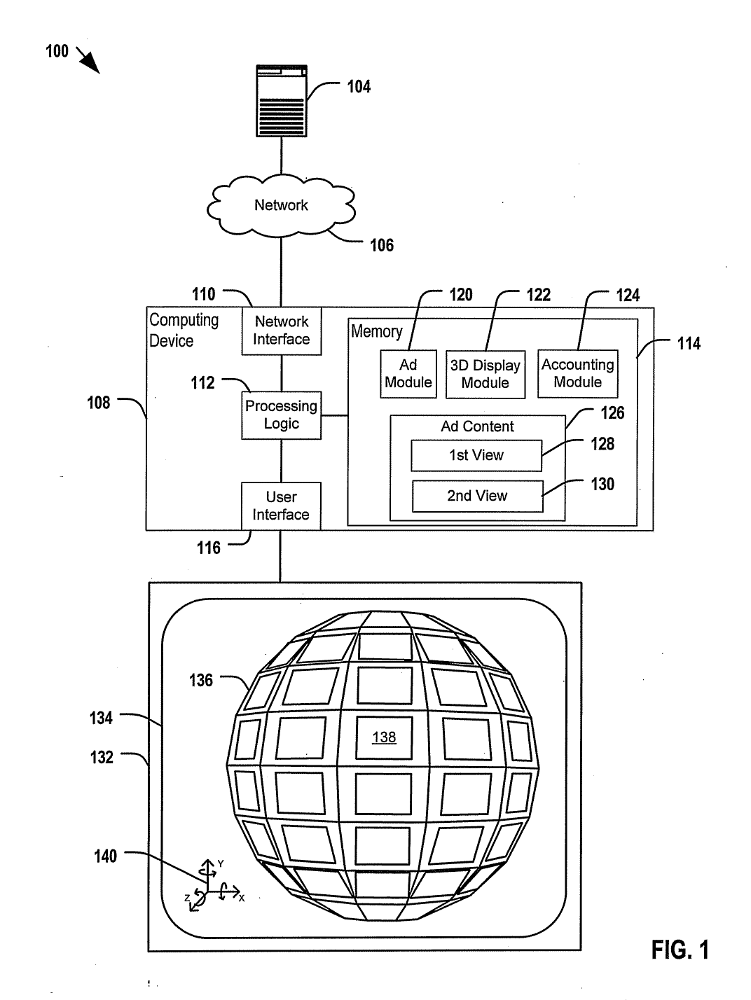

FIG. 1 depicts a first particular embodiment of a system to display advertising content, generally designated 100. The system 100 includes a computing device 108 coupled to a network 106 and to a display device 132. In a particular embodiment, the computing device 108 may include a set-top box device. In an illustrative embodiment, the network 106 may include an access network associated with an Internet Protocol Television (IPTV) system. The network 106 may include or be coupled to one or more content servers, such as the content server 104. The one or more content servers may be adapted to provide content such as multimedia content, text, graphics, data, or any combination thereof, to the computing device 108 via the network 106. In an illustrative embodiment, the content server 104 may be adapted to provide advertising content via the network 106 to the computing device 108 for display at the display device 132.

In a particular embodiment, the computing device 108 includes a network interface 110 to communicate via the network 106 with the one or more content servers and a user interface 116 to communicate with one or more user devices, such as the display device 132, an input device (not shown), other user devices, or any combination thereof. The computing device 108 may also include processing logic 112 and memory 114 accessible to the processing logic 112. The computing device 108 may also include an advertising module 120 adapted to receive advertising content 126 from the content server 104, to select particular advertising content for display to a user, and to modify the display of the advertising content 126. The computing device 108 may also include a three-dimensional graphical display module 122 to generate a three-dimensional graphical display 134. The computing device 108 may also include an accounting module to determine a fee associated with providing the advertising content 126 to users.

In a particular embodiment, the three-dimensional graphical display module 122 is adapted to provide a three-dimensional graphical display 134 at the display device 132. The three-dimensional graphical display 134 may include a plurality of independent display elements, such as a first display element 138. The plurality of independent display elements may be associated with a representation of a three-dimensional object 136. The representation of the three-dimensional object 136 may depict a sphere; a cube; one or more buildings, such as a set of storefronts; any other geometric shape or physical object; or any combination thereof. In an illustrative embodiment, the three-dimensional graphical display 134 may be associated with a theme. For example, the shape of the three-dimensional object 136 and advertising content 126 associated with the three-dimensional object 136 based on the theme. To illustrate, when the theme is related to soccer, the three-dimensional object 136 may be depicted as a sphere and the advertising content 126 may be related to soccer products or services. In a particular illustrative embodiment, the theme may be related to a particular advertiser. For example, the theme may be related to a sporting goods product company. In this example, the shape of the three-dimensional object 136 and advertising content 126 associated with the three-dimensional object 136 may related to the sporting goods product company. To illustrate, the three-dimensional object 136 may represent a locker room and user content may be viewed within the locker room.

In a particular embodiment, the computing device 108 may be adapted to receive user input to modify a viewer perspective related to the three-dimensional graphical display 134. For example, as illustrated by axes 140, the three-dimensional graphical display 134 may be adapted to receive user perspective input to rotate the three-dimensional surface 136 about an X-axis, a Y-axis or a Z-axis, or to translate the three-dimensional surface along the X-axis, the Y-axis, or the Z-axis.

In a particular embodiment, the advertising module 120 selects advertising content 126 for display at one or more of the plurality of independent display elements. In a particular embodiment, the advertising content 126 may include a plurality of views, such as a first view 128, and a second view 130. The first view 128 may be adapted for display at a first viewer perspective and the second view 130 may be adapted for display at a second viewer perspective. For example, the first view 128 may include text in a first orientation, and the second view 130 may include text in a second orientation. In another example, the first view 128 may include only text, and the second view 130 may include text and graphics. In another example, the first view 128 may include only graphics (such as a company logo), and the second view 130 may include text and graphics. In an illustrative embodiment, a view may be adapted for display at a particular viewer perspective in that the view includes information selected and arranged in a manner intended to generate user attention. Additionally the information may be selected and arranged to provide as much detail as possible about the advertising content 126 within the constraints of the viewer perspective. For example, a view adapted for display at a display element having a particular shape may include advertising content with information positioned to accommodate the shape of the display element. In another example, a view adapted for display at a display element having a greater height than width may include text that is oriented vertically rather than horizontally.

The advertising module 120 may select which view of the advertising content 126 to display at a particular display element based on viewer perspective information. For example, the advertising module 120 may select the first view 128 for display at the first display element 138 based on viewer perspective information associated with the first display element 138 and the first view 128. The viewer perspective information may be associated with a size of the first display element 138 in the three-dimensional graphical display 134, a size of the first display element 138 relative to the three-dimensional object 136 or other display elements, a viewing angle associated with the first display element 138, other information related to how the first display element 138 is displayed, or any combination thereof. In a particular embodiment, the advertising content 126 may include more than two views and each view may be associated with viewer perspective information, such as a viewer perspective criterion.

In a particular embodiment, when the three-dimensional graphical display module 122 modifies the viewer perspective, such as by rotating the three-dimensional surface 136 about the X-axis, the Y-axis, or the Z-axis or translating the three-dimensional surface along the X-axis, the Y-axis, or the Z-axis, the advertising module 120 may determine whether the view of the advertising content displayed at a particular display element should be modified. For example, the advertising module 120 may determine whether a viewer perspective criterion is satisfied. When the viewer perspective criterion is satisfied, the advertising module 120 may select another view for display at the particular independent display element. The selected view may be adapted for display at the modified viewer perspective.

In a particular embodiment, the accounting module 124 may determine a fee associated with providing the advertising content 126 to viewers. For example, an advertiser may be charged a fee associated with the advertising content 126 based on the number of views associated with the advertising content 126.

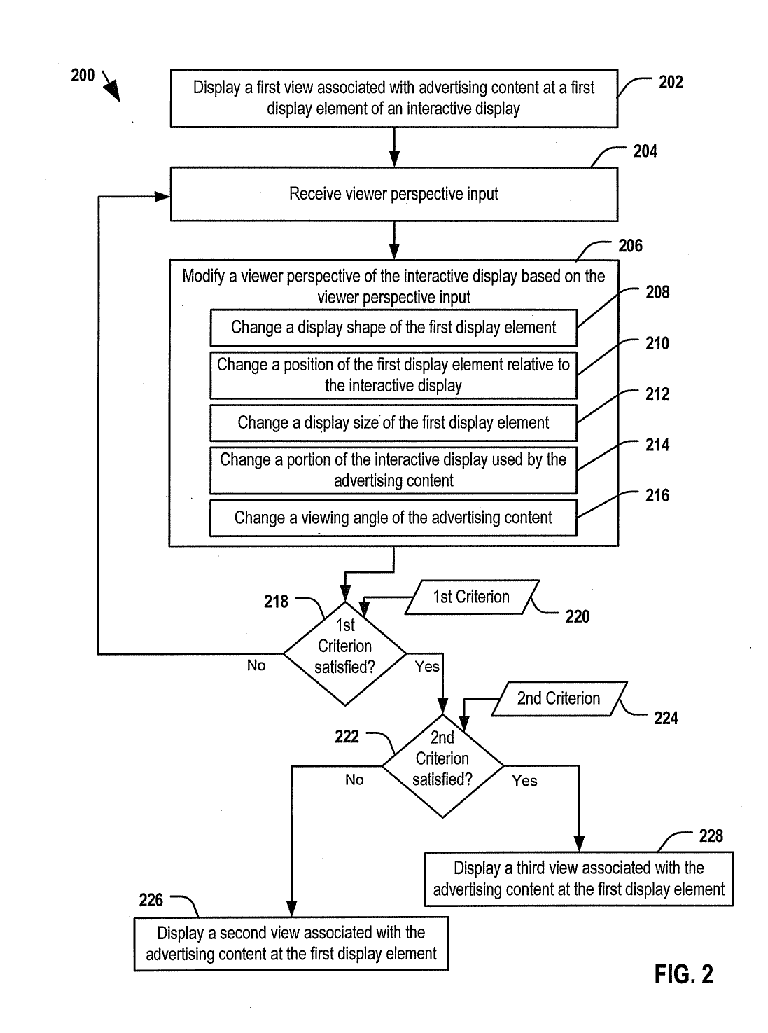

FIG. 2 depicts a particular embodiment of a method of displaying advertising content, generally designated 200. The method 200 includes, at 202, displaying a first view associated with advertising content at a first display element of an interactive display. The advertising content may include a plurality of views, such as the first view and a second view. The interactive display may include a plurality of display elements associated with a representation of a three-dimensional object, such as a representation of a physical object (e.g., one or more building) or a representation of a geometric shape. The method 200 also includes, at 204, receiving viewer perspective input. The viewer perspective input may include a command to rotate the interactive display about an X-axis, a Y-axis, or a Z-axis or a command to translate the interactive display along the X-axis, the Y-axis, or the Z-axis.

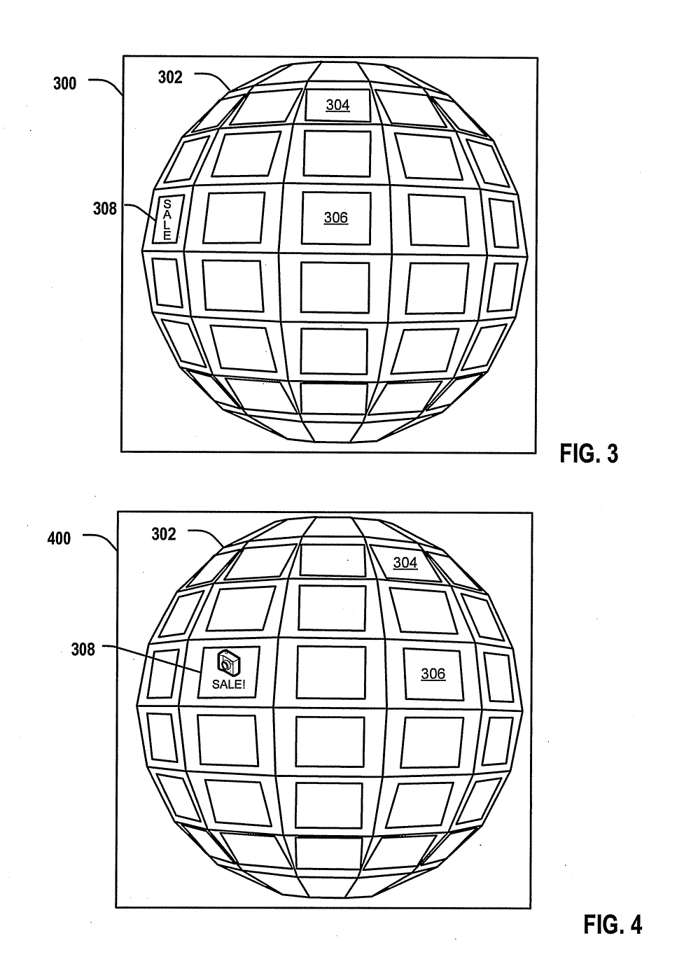

The method 200 also includes, at 206, modifying the interactive display based on the viewer perspective input. In an illustrative embodiment, modifying the interactive display may include changing a display shape of the first display element. For example, referring to FIG. 3, a plurality of display elements are illustrated in a user interface display 300. A first display element 304 and a second display element 306 are illustrated as being shaped differently to account for their respective positions in the user interface display 300. That is, since the first display element 304 and the second display element 306 are associated with a three-dimensional object 302 (in this case a sphere), the first display element 304 and second display element 306 are shaped differently in the user interface display 300 to represent different viewer perspectives of the display elements. Thus, first display element 304 has a shape that is somewhat trapezoidal, whereas the second display element 306 has a shape that is more rectangular. If the user interface display 300 where modified to rotate the three-dimensional object 302 about an axis such that the first display element 304 were substantially centered vertically within the user interface display 300, then the shape of the first display element 304 would be changed to be substantially rectangular, much like second display element 306.

Turning to FIG. 2, modifying the interactive display based on the viewer perspective may include, at 210, changing a position of the first display element relative to the interactive display. To illustrate, referring to FIG. 3, a position associated with the second display element 306 is substantially centered horizontally relative to a user interface display 300. If viewer perspective input is received that rotates the three-dimensional object 302 about a Y-axis, the second display element 306 may be moved to a new position away from the center. For example, the position of the second display element 306 may be shifted to the right, as depicted in FIG. 4. Thus, the position of the second display element 306 in FIG. 3 and the position of the third display element 306 in FIG. 4 illustrate changing the position of a display element relative to the interactive display based on received viewer perspective input.

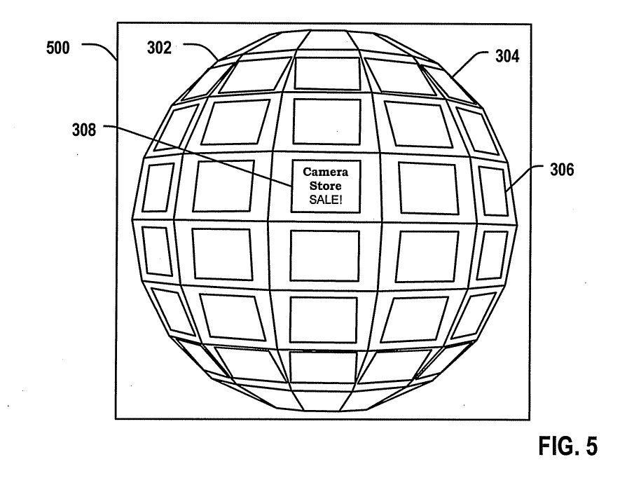

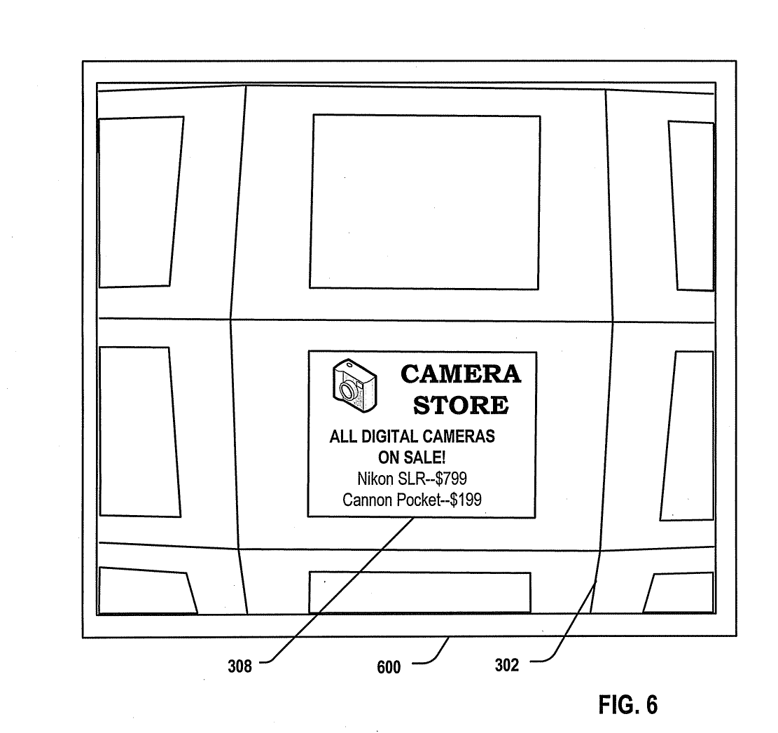

Turning to FIG. 2, modifying the interactive display based on viewer perspective input may include, at 212, changing a display size of the first display element. Referring to FIG. 5, a third display element 308 is shown substantially centered horizontally relative to a user interface display 500. Referring to FIG. 6, the third display element 312 is also depicted substantially centered horizontally relative to a user interface display 600; however, a display size of the third display element 312 in FIG. 6 is increased relative to the display size of the third display element 312 depicted in FIG. 5. The change in the display size illustrated by the third display element 312 of FIG. 5 and the third display element 312 of FIG. 6 illustrates modifying the user interface display to change the size of the third display element 312. The size of the third display element 312 may be changed based on translation of the three-dimensional object 302 along a Z-axis. Translation of the three-dimensional object 302 along the Z-axis may commonly be referred to as “zooming in” (i.e., closer to) or “zooming out” (i.e., further from) the three-dimensional object 302.

Turning to FIG. 2, modifying the viewer perspective of the interactive display based on viewer perspective input may include, at 214, changing a portion of the interactive display used by the advertising content. The differences between the third display element 312 in FIG. 5 and the third display element 312 in FIG. 6 illustrate changing the portion of the interactive display used by the advertising content. That is, in FIG. 5, the third display element 312 uses a substantially smaller portion of the user interface display 500 than the third display element 312 in FIG. 6 does.

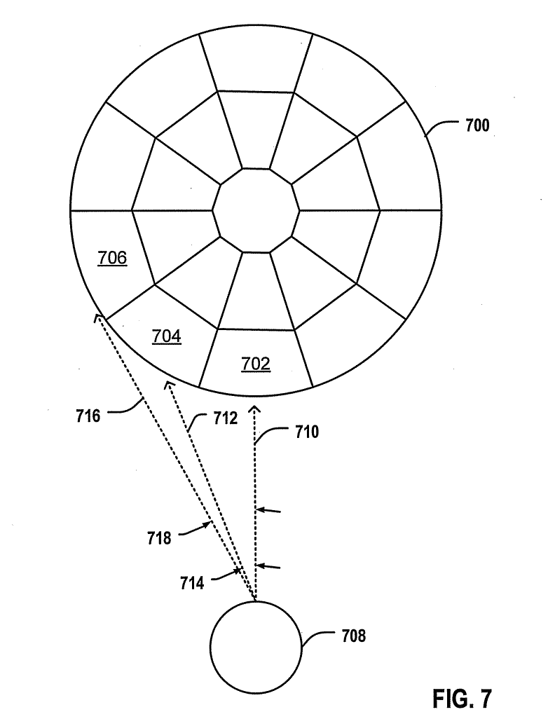

Turning to FIG. 2, modifying the interactive display based on the user viewer perspective may include, at 216, changing a viewing angle of the advertising content. Referring to FIG. 7, changing the viewing angle of the advertising content is illustrated. FIG. 7 includes a viewer 708 positioned relative to a top view of a representation of the three-dimensional object 700. A plurality of display elements, such as a first display element 702, a second display element 704 and a third display element 706 are associated with the representation of the three-dimensional object 700. The representation of the three-dimensional object 700 is for illustration purposes only and is not intended to indicate that the viewer 708 is looking at an actual spherical object, rather the representation of the three-dimensional object 700 is intended only to illustrate modifying a viewing angle. The viewer 708 may observe advertising content depicted at the first display element 702 along a direct line of sight 710. However, to observe advertising content depicted at the second display element 704, the viewer 708 looks along a second line of sight 712. The angle between the first line of sight 710 and second line of sight 712 is a first viewing angle 714. Similarly, to observe advertising content depicted at the third display element 706 the viewer 708 looks along a third line of sight 716. The angle between the third line of sight 716 and first line of sight 710 is a second viewing angle 718. When the three-dimensional object 700 is rotated, for example in response to viewer perspective input, the display elements may be modified to render display elements more realistically based on the modified viewer perspective.

Turning to FIG. 2, the method 200 also includes, at 218, determining whether a first criterion 220 is satisfied after modifying the interactive display. The first criterion 220 may be associated with the viewer perspective and a particular view displayed. For example, the first criterion may be associated with the first view and may indicate when the first view should be changed. The first criterion may be associated with a display shape of the first display element, a display size of the first display element, a position of the first display element, a portion of the interactive display used by the advertising content, a viewing angle of the advertising content, any other view selection criteria, or any combination thereof. To illustrate, when the display size of the first display element increases above the criterion, the first criterion may be satisfied. When the first criterion 220 is not satisfied, the method 200 may include awaiting further viewer perspective input, at 204.

When the first criterion 220 is satisfied, the method 200 may include, at 222, determining whether a second criterion 224 is satisfied. The second criterion 224 may be associated with a second view. When the second criterion 224 is not satisfied the method may include, at 226, displaying the second view associated with the advertising content at the first display element. When the second criterion 224 is satisfied, the method 200 may include, at 228, displaying a third view associated with the advertising content at the first display element. In a particular embodiment, the advertising content may be associated with more than three views. In this embodiment, additional criterion may be checked to determine which view to display after the viewer perspective is modified.

FIGS. 3-6 illustrate changes made to a user interface display in response to viewer perspective input. Referring to FIG. 3 a first particular embodiment of a user interface display for displaying advertising content is depicted, and generally designated 300. The user interface display 300 includes a plurality of display elements associated with a representation of a three-dimensional object 302. The display elements include a first display element 304, a second display element 306, and a third display element 308. The third display element 308 includes a first view associated with advertising content. The first view includes the text “SALE.” In another particular illustrative embodiment, the first view may include only graphics. In yet another particular illustrative embodiment, the first view may include both text and graphics.

FIG. 4 depicts a second particular embodiment of a user interface display for displaying advertising content, generally designated 400. The user interface display 400 includes the three-dimensional object 302 and the display elements 304, 306 and 308. In FIG. 4, the three-dimensional object 302 has been rotated about a Y-axis relative to a position of the three-dimensional object 302 as depicted in FIG. 3. Thus, the first display element 304, the second display element 306, and the third display element 308 have shifted to the right. Additionally, the first view associated with the advertising content, as depicted in FIG. 3, has been replaced with a second view. The second view of the advertising content includes graphics and text. In an illustrative embodiment, the second view may include graphics only, text only, or any combination thereof. For example, the second view may include information associated with the first view plus additional information. Thus, the first view included only the text “SALE”, whereas the second view includes the text “SALE” and includes additional graphical information. In a particular embodiment, the second view may be adapted for display in a display element having the particular size, shape, position, viewing angle, or other viewer perspective criterion of the third display element 308 as illustrated in FIG. 4.

FIG. 5 depicts a third particular embodiment of a user interface display for displaying advertising content, generally designated 500. In FIG. 5, the three-dimensional object 302 has been rotated about a Y-axis relative to position of the three-dimensional object 302 as depicted in FIG. 4. Thus, the first display element 304, the second display element 306, and the third display element 308 have shifted to the right. Additionally, the second view associated with the advertising content, as depicted in FIG. 4, has been replaced with a third view. The third view of the advertising content includes additional information, such as a company logo (illustrated as “Camera Store”). In particular embodiments, the third view may include graphics, text, or any combination thereof. Additionally, the third view may be adapted for display in a display element having the particular size, shape, position, viewing angle, or other viewer perspective criterion of the third display element 308 as illustrated in FIG. 5.

FIG. 6 depicts a fourth particular embodiment of a user interface display for displaying advertising content, generally designated 600. The user interface display 600 includes the third display element 308 after a translation of the representation of a three-dimensional object 302 along a Z-axis. That is, the user interface display 600 includes a zoomed in view of the third display element 308. The third display element 308 includes a fourth view associated with the advertising content. The fourth view of the advertising content includes additional information, such as the company logo, graphics and additional information about sales prices for particular products. In particular embodiments, the fourth view may include graphics, text, or any combination thereof. Additionally, the fourth view may be adapted for display in a display element having the particular size, shape, position, viewing angle, or other viewer perspective criterion of the third display element 308 as illustrated in FIG. 6.

In conjunction with the configuration of structure described herein, the system and method disclosed provide display of advertising content. In a particular embodiment, a computing device displays a first view associated with advertising content at an interactive display. The computing device also receives viewer perspective input and modifies a viewer perspective of the interactive display based on the input. The computing device also displays a second view associated with the advertising content based on the modified viewer perspective.

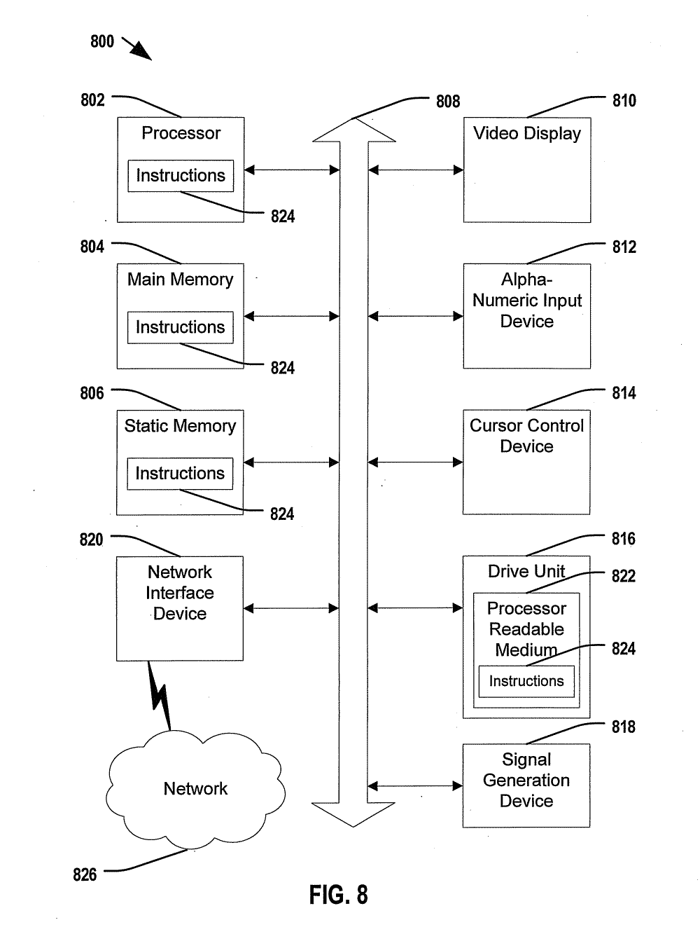

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices. For example, the computer system 800 may include or be included within any one or more of the computing devices, display devices, or content servers depicted in FIG. 1.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse or remote control device. The computer system 800 can also include a disk drive unit 816, a signal generation device 818, such as a speaker, and a network interface device 820.

In a particular embodiment, as depicted in FIG. 8, the disk drive unit 816 may include a processor-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include processor-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a processor-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the processor-readable medium is shown to be a single medium, the term “processor-readable medium” includes a single medium or multiple media, such as a centralized or distributed database, and/or associated caches and servers that store one or more sets of instructions. The term “processor-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the processor-readable medium can include a solid-state memory such as a memory card or other package that houses one or more non-volatile read-only memories. Further, the processor-readable medium can be a random access memory or other volatile re-writable memory. Additionally, the processor-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a processor-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of displaying advertising content, the method comprising:
displaying a first view associated with advertising content at a first display element of an interactive display, the advertising content including at least the first view and a second view;
receiving viewer perspective input;
modifying a viewer perspective of the interactive display based on the viewer perspective input; and
displaying the second view associated with the advertising content based on the modified viewer perspective.

2. The method of claim 1, wherein displaying the second view associated with the advertisement content based on the modified viewer perspective comprises displaying the second view when a viewer perspective criterion is satisfied.

3. The method of claim 2, wherein the viewer perspective criterion is related to a display shape of the first display element, and wherein the first view is adapted for display when the first display element has a first shape and the second view is adapted for display when the first display element has a second shape.

4. The method of claim 2, wherein the viewer perspective criterion is related to a display size of the first display element, and wherein the first view is adapted for display when the first display element has a first size and the second view is adapted for display when the first display element has a second size.

5. The method of claim 2, wherein the viewer perspective criterion is related to a position of the first display element, and wherein the first view is adapted for display when the first display element has a first position and the second view is adapted for display when the first display element has a second position.

6. The method of claim 1, wherein modifying the viewer perspective of the interactive display includes changing a display shape of the first display element.

7. The method of claim 1, wherein modifying the viewer perspective of the interactive display includes changing a display size of the first display element.

8. The method of claim 1, wherein modifying the viewer perspective of the interactive display includes changing a position of the first display element relative to the interactive display.

9. The method of claim 1, wherein the interactive display comprises a plurality of display elements associated with a representation of a three-dimensional surface.

10. The method of claim 1, wherein the second view includes more detailed information related to the advertising content than the first view.

11. A system to display advertising content, the system comprising:
a three-dimensional graphical display module to generate an interactive three-dimensional user interface display;
an advertising module to display advertising content at the three-dimensional user interface display; and
advertising content displayable using a plurality of views, wherein a first view of the plurality of views is adapted for display at a first viewer perspective and a second view of the plurality of views is adapted for display at a second viewer perspective.

12. The system of claim 11, wherein the three-dimensional graphical display module modifies a viewer perspective of the interactive three-dimensional user interface display based on user input and determines which of the plurality of views to display based on the modified viewer perspective.

13. The system of claim 11, wherein the first view includes text in a first orientation and the second view includes text in a second orientation.

14. The system of claim 11, wherein the first view includes first text and the second view includes second text.

15. The system of claim 11, wherein the first view includes only graphics and the second view includes text and graphics.

16. The system of claim 11, wherein the first view includes only text and the second view includes text and graphics.

17. The system of claim 11, further comprising a network interface to receive the first advertising content from an Internet Protocol Television (IPTV) system.

18. The system of claim 11, further comprising an accounting module to determine a fee of an advertiser associated with the advertising content.

19. The system of claim 18, wherein the fee is determined based at least partially on how many views are associated with the plurality of views.

20. A processor-readable medium including instructions executable by a processor to perform a method comprising:
displaying a first view associated with advertising content at a first display element of an interactive display, the advertising content including at least the first view and a second view;
receiving viewer perspective input;
modifying a viewer perspective of the interactive display based on the viewer perspective input; and
displaying the second view associated with the advertising content based on the modified viewer perspective.

21. The processor-readable medium of claim 20, wherein modifying the viewer perspective includes changing a portion of the interactive display used by the advertising content, and wherein the second view is displayed when the portion of the interactive display used by the advertising content satisfies a first criterion.

22. The processor-readable medium of claim 20, wherein the method further comprises displaying a third view associated with the advertising content at the first display element when the portion of the interactive display used by the advertising content satisfies a second criterion.

23. The processor-readable medium of claim 22, wherein the first view includes an advertiser logo, the second view includes the advertiser logo and graphics, and the third view includes the advertiser logo, graphics and text.

24. The processor-readable medium of claim 20, wherein modifying the viewer perspective includes changing a viewing angle of the advertising content, and wherein the second view is displayed when the viewing angle satisfies a viewing angle criterion.
